(19) United States
(12) Patent Application Publication
(10) Pub. No.: US 2006/0220398 A1
(43) Pub. Date: Oct. 5, 2006

(54) Ergonomic manual actuator for door locks

(75) Inventors: Luis Angel Ruano, Guipuzcoa (ES); Eneko Gaton, Renteria Guipuzcoa (ES)

Correspondence Address: LUCAS & MERCANTI, LLP, 475 PARK AVENUE SOUTH, 15TH FLOOR, NEW YORK, NY, 10016, US

(73) Assignee: TALLERES DE ESCORIAZA, S.A.

(21) Appl. No.: 11/391,527

(22) Filed: Mar. 28, 2006

(30) Foreign Application Priority Data
Mar. 30, 2005 (ES) 200500735

(51) Int. Cl. E05B 1/00

(52) U.S. Cl. 292/347

(57) ABSTRACT

Ergonomic manual actuator for door locks that consists of a rotary handle (1) whose body is of such a size as to promote convenient grasping by the user's hand and that has a basically cylindrical form that extends, from its planar outer front end (4), without forming any slimmer neck, to the actual decorative plate (2) applied to the panel of the door (6), and the basic cylindrical form of this rotary handle (1) is that of a smooth perimetral outline interrupted by a surface unevenness (3) that extends, straight, from the outside toward the door right along the rotary handle (1), and the surface unevenness (3) has a cross section in profile that is ideal for receiving on it the shape of the tip of the thumb (7) of the user's hand.

### FIELD OF THE INVENTION

This invention relates to a novel concept of rotary actuator that can be applied to door locks.

### PRIOR ART

Nowadays, only two rotary grasping elements are used for actuating locks: Handle and knob.

With reference, specifically to knobs, this is a rotary grasping element that is grasped with the hand and presents problems of grip in many circumstances, for example when the hand or the actual knob is damp or greasy or when we attempt to actuate it with a gloved hand, or when the hand is swollen, or when the lock mechanism is heavy or stiff, inter alia. Aside from the difficulty and inconvenience inherent in known knob designs, personal injury or physical damage may also arise as a result of clumsy opening, i.e. when one believes that one has correctly carried out the opening maneuver but the door does not open because the hand has slipped on the knob and the rotation necessary for said opening has not been fully produced. This then gives rise to stumbling, when we might be injured by a blow or when we might drop articles we might be carrying with us, such as glassware or chinaware, which, in addition to breaking, may cut us, or articles such as heavy items that may fall onto our foot, crushing it.

These problems of grip derive from the traditional knob form, which, perhaps as it is based on early non-rotary ball handles, always has a slimmer neck at the end where they are fixed onto the decorative plate that covers the hole made in the door for installation of the lock embedded therein. Any attempts at generating a rough surface, by striating the knob, have not proved successful because they excessively complicated manufacture, had a very influential effect on esthetics and were insufficiently effective.

### EXPLANATION OF THE INVENTION AND ADVANTAGES

Given this state of affairs, the present invention proposes an ergonomic solution for a door-lock actuator that consists of a rotary handle whose body is of such a size as to promote convenient grasping by the user's hand and that has a basically cylindrical form that extends, from its planar outer front end, without forming any slimmer neck, to the actual decorative plate applied to the panel of the door, and the basic cylindrical form of this rotary handle is that of a smooth perimetral outline interrupted by a surface unevenness that extends, straight, from the outside toward the door right along the rotary handle, and the surface unevenness has a cross section in profile that is ideal for receiving on it the shape of the tip of the thumb of the user's hand. This solution naturally enables the hand to grip perfectly, and this is reflected in great actuating efficiency even in circumstances when slipping is likely to occur, such as those mentioned above. This is achieved by virtue of the thumb finding a firm seat in the surface unevenness provided on the periphery of this actuator. In addition, this solution can be manufactured in a simple manner and does not restrict the product's final esthetics. Rather, it confers on it great versatility in that its basically smooth surface allows many possible finishes and decorative effects that can be achieved in a simple manner. Even its simplicity and purity of line is inherently beautiful.

With the actuator of the invention, it is not the above-mentioned disadvantages alone that are solved but, in addition, an actuator is achieved that is suitable for small or weak hands (seniors, children, etc.), and one that is also suitable for use by handicapped persons with disabled hands or with prostheses, for whom conventional knobs are practically impossible to operate.

In accordance with the invention, one possible embodiment consists in said surface unevenness being a depression of arcuate profile that is suitable for being easily adapted to the tip of said thumb. A variant on this consists in, with regards to the position where it is mounted on the door lock, said depression being centered in terms of the vertical, which allows it to be applied, without distinction, to rightward and leftward opening rotations and also to right-handed and left-handed people. Another variant embodiment consists in, with regards to the position where it is mounted on the door lock, said depression being offset from the vertical by an angle of rotation that corresponds to the position of the thumb of the user's hand when grasping the rotary handle, which means that the ergonomic actuator would work properly, i.e. depending on the side toward which the angle of rotation were offset from the mounting vertical, it would be suitable for turning to the right or to the left for opening or for left-handed or right-handed users. In connection with these two variant embodiments, the invention makes provision for the fact that, with regards to said vertical of the mounting position, said rotary handle can be mounted, without distinction, in such a manner that said depression is either centered on said mounting vertical or is on one side or the other of said vertical in terms of measurement of said angle of rotation, which makes it possible for the rotary handle always to have the same configuration and for it to be by means of mounting that one result or the other is achieved in terms of the position of the depression in relation to the vertical of said mounting.

A further possible embodiment of the surface unevenness is a peripheral projection in the form of a wave crest that has its concave side oriented toward the position of the user's thumb and is configured in a suitable manner for adaptation to the shape of the tip of the thumb of the user's hand. This solution works depending on which way the projection faces. In return, it is particularly esthetically pleasing.

A particular characteristic of the invention that will be explained in detail in the description of the preferred embodiment illustrated in the appended drawings consists in that, now, grasping is not achieved by using the palm of the hand but, fundamentally, with the fingers, which is more effective.

### DRAWINGS AND REFERENCES

In order better to understand the nature of the present invention, the attached drawings show a preferred industrial embodiment simply by way of illustrative and non-limiting example.

FIG. 1 is a perspective view of an embodiment of the subject of the invention, including a representation of a user's hand.

FIG. 2 is a front view in orthogonal projection of a mounting such as that of FIG. 1.

FIG. 3 is the left side view corresponding to FIG. 2.

FIG. 4 is similar to FIG. 1, but shows the depression (3a) in a position symmetrical to the previous one in terms of the mounting vertical.

FIG. 5 is a representation similar to FIG. 2, but with reference to the variant embodiment shown in FIG. 4.

FIG. 6 is similar to FIGS. 2 and 5, but shows the variant embodiment in which the depression (3a) is centered on the mounting vertical.

FIG. 7 is a perspective view illustrating grasping, for the embodiment of the invention that relates to the wave-crest projection (3b), with the user's hand.

FIGS. 8, 9, and 10 are views equivalent to FIGS. 4, 2, and 3, but they relate to an embodiment in which the rotary handle (1) has a peripheral projection (3b) in the form of a wave crest.

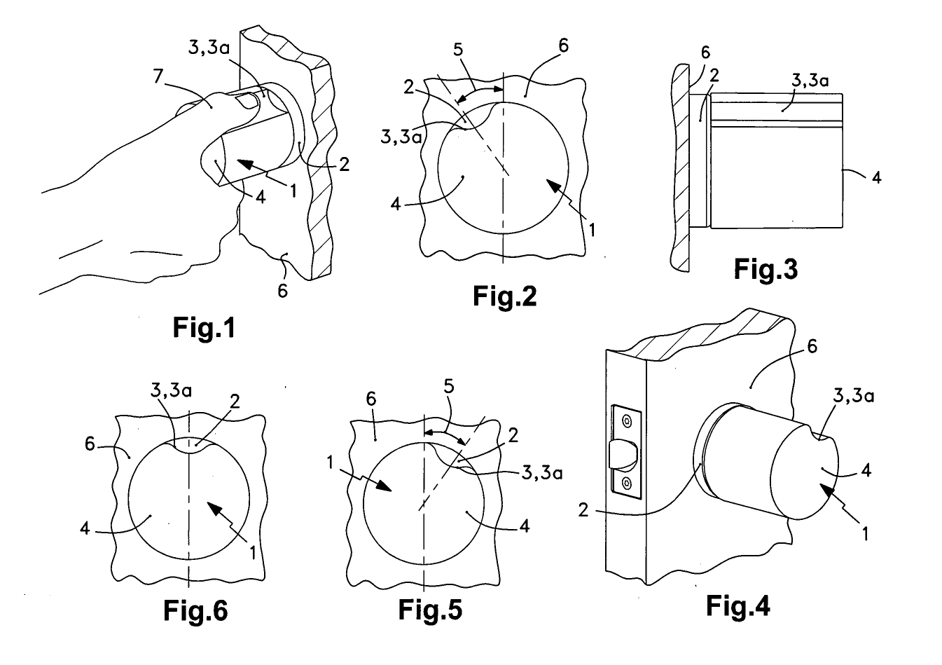

The following references are indicated in said figures:
1. Rotary handle
2. Decorative plate
3. Surface unevenness
3a. Peripheral depression of the rotary handle (1)
3b. Peripheral wave-crest projection
4. Planar outer front end
5. Offset angle of rotation
6. Door
7. User's thumb

### DESCRIPTION OF A PREFERRED EMBODIMENT

In connection with the drawings and references listed above, the attached drawings illustrate the subject of the invention in two preferred embodiments and certain mounting variants, which subject of the invention is, specifically, a rotary handle (1) whose body is of such a size as to promote convenient grasping by the user's hand and that has a basically cylindrical form that extends, from its planar outer front end (4), without forming any slimmer neck, to the actual decorative plate (2) applied to the panel of the door (6), and the basic cylindrical form of this rotary handle (1) is that of a smooth perimetral outline interrupted by a surface unevenness (3) that extends, straight, from the outside toward the door right along the rotary handle (1), and the surface unevenness (3) has a cross section in profile that is ideal for receiving on it the shape of the tip of the thumb (7) of the user's hand.

The particular characteristic of having no neck at the end where it is coupled to the decorative plate (2) is translated into an essentially cylindrical body that provides sufficient space to promote the production of an ergonomic seat for the user's actuating-hand thumb. This provides a method of grasping that is different from that employed for a traditional knob, where this grasping takes place with the palm of the hand and gripping is less secure, whereas, with the handle proposed, it is (FIG. 7) the fingers of the hand that are responsible for grasping (between the tip of the thumb and the side of the index finger, which forms a clamp or hook with said thumb), which allows easy, effective application of torque on the handle, the thumb having said ergonomic seat on the periphery of the rotary handle (1).

A preferred embodiment of the invention consists in said surface unevenness (3) being a depression (3a) of arcuate profile that is suitable for being easily adapted to the tip of said thumb (7). A variant on this is (FIG. 6) that, with regards to the position where it is mounted on the door lock of the (6), said depression (3a) is centered in terms of the vertical. Another variant of this embodiment is (FIGS. 2 and 5) that, with regards to the position where it is mounted on the lock of the door (6), said depression (3a) is offset from the vertical by an angle (5) of rotation that corresponds to the position of the thumb of the user's hand when grasping the rotary handle (1). In connection with these variant embodiments, the invention makes provision, in terms of said vertical of the mounting position, for said rotary handle (1) to be capable of being mounted, without distinction, in such a manner that said depression (3a) is either centered on said mounting vertical or is on one side or the other of said vertical in terms of measurement of said angle (5) of rotation. Therefore, in terms of this embodiment, only one form of rotary handle (1) is required, the latter being provided with means for the three alternate mounting methods that correspond to the indicated variant embodiments in terms of the mounting vertical.

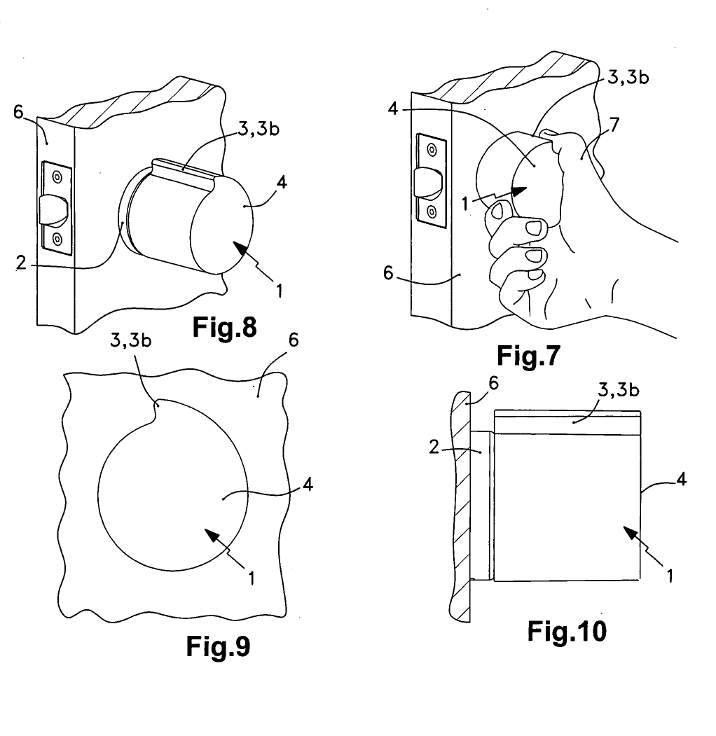

In accordance with a further preferred embodiment of the invention, said surface unevenness (3) is a peripheral projection (3b) in the form of a wave crest that has its concave side oriented toward the position of the user's thumb and is configured in a suitable manner for adaptation to the shape of the tip of the thumb (7) of the user's hand. FIG. 9 illustrates a variant on this that is envisaged for a rightward operating rotation, but there is an obvious variant for a leftward operating rotation, which is completely symmetrical in terms of the mounting vertical of said FIG. 9.

With the surface unevenness (3) according to the invention, the actuator may be opened not only by weak hands but also by disabled persons and even those fitted with prostheses or artificial hands and who currently find it impossible to use knobs—with the invention they are able to squeeze the actuator, hooking one of the “fingers” of the artificial hand onto the surface unevenness (3).

1. Ergonomic manual actuator for door locks, characterized in that it consists of a rotary handle (1) whose body is of such a size as to promote convenient grasping by the user's hand and that has a basically cylindrical form that extends, from its planar outer front end (4), without forming any slimmer neck, to the actual decorative plate (2) applied to the panel of the door (6), and the basic cylindrical form of this rotary handle (1) is that of a smooth perimetral outline interrupted by a surface unevenness (3) that extends, straight, from the outside toward the door right along the rotary-handle (1), and the surface unevenness (3) has a cross section in profile that is ideal for receiving on it the shape of the tip of the thumb (7) of the user's hand.

2. Ergonomic manual actuator for door locks according to claim 1, characterized in that said surface unevenness (3) is a depression (3a) of arcuate profile that is suitable for being easily adapted to the tip of said thumb (7).

3. Ergonomic manual actuator for door locks according to claim 2, characterized in that, with regards to the position where it is mounted on the lock of the door (6), said depression (3a) is centered in terms of the vertical.

4. Ergonomic manual actuator for door locks according to claim 2, characterized in that, with regards to the position where it is mounted on the lock of the door (6), said depression (3a) is offset from the vertical by an angle (5) of rotation that corresponds to the position of the thumb of the user's hand when grasping the rotary handle (1).

5. Ergonomic manual actuator for door locks according to claims 3 and 4, characterized in that, with regards to said vertical of the mounting position, said rotary handle (1) can be mounted, without distinction, in such a manner that said depression (3a) is either centered on said mounting vertical or is on one side or the other of said vertical in terms of measurement of said angle (5) of rotation.

6. Ergonomic manual actuator for door locks according to claim 1, characterized in that said surface unevenness (3) is a peripheral projection (3b) in the form of a wave crest that has its concave side oriented toward the position of the user's thumb and is configured in a suitable manner for adaptation to the shape of the tip of the thumb (7) of the user's hand.
